(19) United States
(12) Patent Application Publication
(10) Pub. No.: US 2014/0237625 A1
(43) Pub. Date: Aug. 21, 2014

(54) METHOD FOR UNIFIED END USER LICENSE MANAGEMENT IN A DRM SYSTEM

(71) Applicant: PROTECTION TECHNOLOGIES RESEARCH, LLC, Moscow (RU)

(72) Inventor: Alexander Nikolaevich Zatsepin, Moscow (RU)

(21) Appl. No.: 13/989,071

(22) PCT Filed: Feb. 21, 2013
(86) PCT No.: PCT/RU2013/000139

§ 371 Date: May 23, 2013

(51) Int. Cl. G06F 21/10

(52) U.S. Cl. CPC G06F 21/105
USPC 726/28

(57) ABSTRACT

A method for end user license management comprising maintaining a server-side DRM database of information about licensed objects, the licensed objects including application software, digital content and services; verifying, upon an end user request to utilize the licensed object, validity of a license held by the end user; providing, to the end user, permission to use the licensed object if the verification is successful; rejecting the request to use the licensed object if the verification is not successful; periodically receiving requests to continue utilize the licensed object, and verifying continued validity of a license held by the end user; providing, to the end user, continued permission to use the licensed object if the verification is successful; and rejecting the request to continue using the licensed object if the verification is not successful.

### CROSS REFERENCE TO RELATED APPLICATIONS

The present application is a US National Phase of PCT/RU2013/000139, filed on Feb. 21, 2013.

### BACKGROUND OF THE INVENTION

1. Field of the Invention

The present invention is related to digital rights management (DRM) systems, and more particularly, to methods and system of content protection and prevention of illegal distribution in the context of licensing and DRM.

2. Description of the Related Art

In order to provide protection for the rights of content owners to digital content, and to manage the licenses for the use of the digital content, DRM systems are widely used today. Modern DRM systems permit protection of application software for computers, including applications and games, as well as content, such as electronic books, audio visual content, and so on. DRM systems protect either only applications, or only content, which is mostly due to the fact that different mechanisms and technologies are used for protection of application software versus digital content.

When modern DRM systems are designed, typically license management is rarely considered, where the licenses relate to services, such as services provided through a computer, since sale of services and protection of services from unauthorized use is usually addressed through technologies such as passwords for access to the server and entries on the server that relate to which users are allowed to do which activities.

Modern DRM systems are also used when distribution platforms for sale of digital content are created. With such platforms, in addition to the task of integration of the platform with the DRM system, there is a problem of placing digital information of very different types into the same sales platform (i.e., applications, content and services). This task is made more particularly challenging due to the non-universality of the DRM systems, as well as the different nature of the various digital information that needs to be protected.

Accordingly, a more universal approach to DRM is desired.

### SUMMARY OF THE INVENTION

The present invention provides an effective solution for DRM license management that substantially obviates one or several of the disadvantages of the related art.

In one aspect, a computer-implemented method for end user license management is provided, the method comprising maintaining a database of information about licensed objects, the licensed objects including application software, digital content and services; verifying, upon an end user request to utilize the licensed object, validity of a license held by the end user; providing, to the end user, permission to use the licensed object if the verification is successful; rejecting the request to use the licensed object if the verification is not successful; periodically receiving requests to continue utilize the licensed object, and verifying continued validity of a license held by the end user; providing, to the end user, continued permission to use the licensed object if the verification is successful; and rejecting the request to continue using the licensed object if the verification is not successful.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates a flow chart of a method for end user license management for an application, in accordance with the exemplary embodiment;

FIG. 2 illustrates an exemplary DRM system, in accordance with the exemplary embodiment;

FIG. 3 illustrates a schematic diagram of an exemplary computer (node) or server that can be used in the invention.

### DETAILED DESCRIPTION OF THE PREFERRED EMBODIMENTS

Reference will now be made in detail to the preferred embodiments of the present invention, examples of which are illustrated in the accompanying drawings.

The present invention is related to a method of controlling and managing licenses, and permits, implementing within a framework of a single DRM system, control and management of licenses for content, application software and services. Such universality of the DRM system permits using the same control mechanisms for users, payments, restrictions, reports, and so on for all types of licensed objects (applications, digital content, services), which reduces expenses involved in creation and operation of the DRM system.

The following elements are combined in the exemplary embodiment:

The use of a single representation model of a license in a database, for all types of objects that are being licensed (applications, digital content documents, services), and the same logic for verification of whether the license is current, for all licensable objects. The proposed model for license representation includes the following fields: an identifier of the object being licensed, an identifier of the end user or a unique identifier of a license, the calendar time and date of the start and end of the permitted period of use of the licensed object, a common permitted length of time for the licensed object, total permitted number of times of use of the licensed object, permitted number of simultaneous (parallel) uses of the licensed object, information about actual use of the licensed object (in other words a counter of the time that the licensed object has been used, a counter of the number of times the licensed object has been invoked, a counter of the current number of simultaneous uses of the licensed object).

The DRM server conducts a check of the validity of the license every time the licensed object starts being used, and, optionally, during the use of the licensed object.

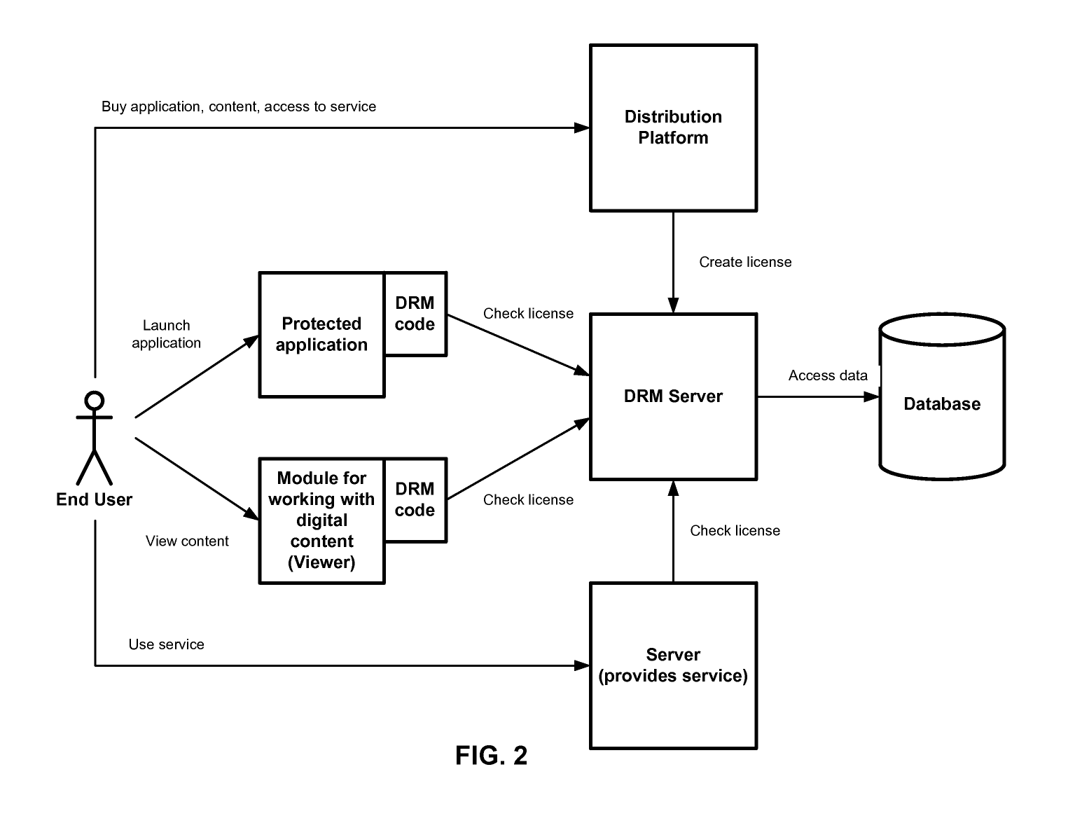

The following example illustrates the use of the method for license management in a DRM system, where the system includes the components shown in FIG. 2):

A database that stores information about the licenses;

A DRM server that manages the licenses;

A distribution platform, through which the end user can acquire the applications, digital content and services;

A server that provides the services;

A protected application with embedded DRM sub-programs, that works on a computer or a mobile device of the end user; and

A special module for viewing or working with the digital content and with embedded DRM sub-programs, that works on the computer or mobile device of the end user.

The proposed method for license management uses a DRM system with a unified representation model for the license in the database. The model includes the following elements: identifier of the licensed object (application, digital content, service); an identifier of the end user (for example, a log-in) and/or a unique identifier of the license that is given to the end user at the time of purchase; calendar time of the start and end of the period when the use of the licensed object is permitted; total permitted time of usage of the licensed object; total permitted number of uses of the licensed object; total permitted number of simultaneous uses of the licensed object; information about actual use of the licensed object (such as a counter of the time the licensed object was used, a counter of the number of times the licensed object was accessed, a counter of the current number of simultaneous uses of the licensed object). The proposed method for managing licenses includes the performance of the steps described below, during operations that involve the licenses.

When an end user purchases a license, the following operations are performed:

The end user purchases the license for the use of the licensed object through the distribution platform. The distribution platform, through the use of the DRM server, creates an entry in the database with the information about the license of the end user. The entry in the database is tied to the end user through the identifier of the end user (such as a log-in), or through the identifier of the license given to the end user at the time of purchase.

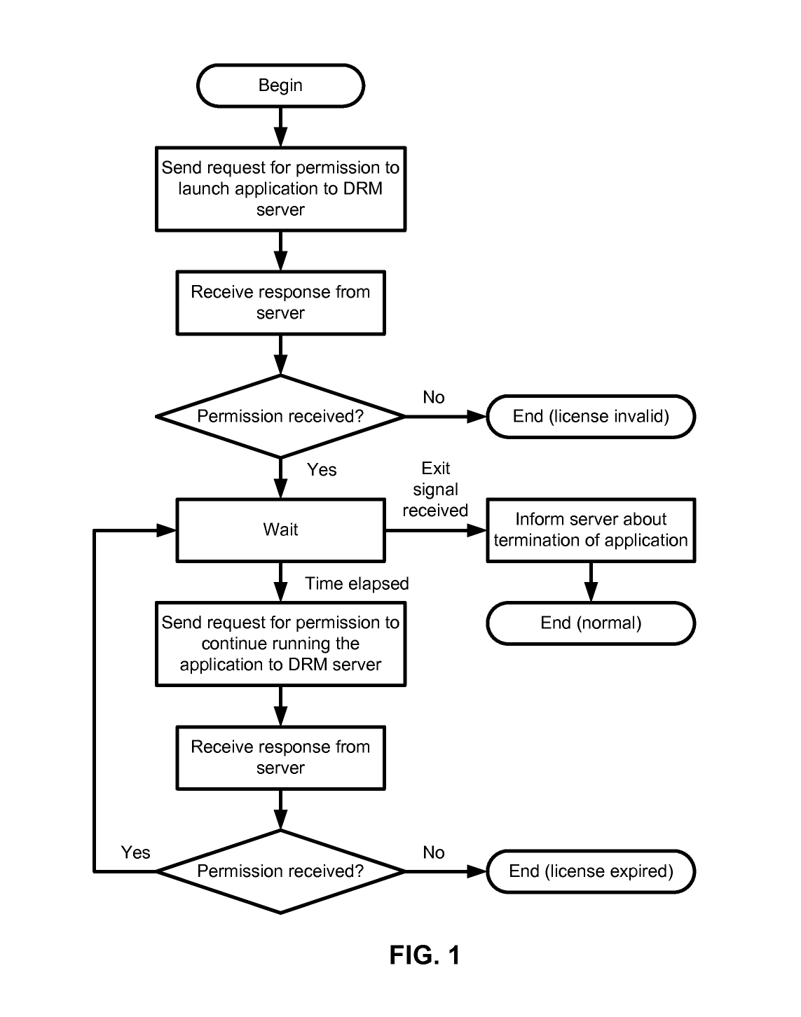

When working with the application or a document containing digital content, the end user downloads the application or document to his computer or mobile device. FIG. 1 illustrates a flow chart of a method for end user license management for an application, in accordance with the exemplary embodiment.

When launching an application, the following steps are performed:

The end user launches the application. Immediately after that, a DRM sub-program embedded in the application begins execution. The sub-program sends, to the DRM server, a request for permission to launch the application. The request contains an identifier of the application and information about how the application is tied to the end user and/or to the license (in other words, the identifier of the end user and/or the identifier of the license).

The DRM server verifies the license (see also below), and, if successful, gives the permission to launch the application.

The DRM subprogram that is embedded in the application verifies that the permission to launch the application is valid, and then proceeds to launch the application.

When the application is running, the following tasks are periodically performed:

The DRM subprogram embedded in the application periodically transmits a request to the DRM server to continue running the application. The request is similar to the request to permit the launcher of the application, but contains additional information about how long the application has been running, since the time of start or launch. The DRM server verifies the license (see also below), and, if the verification is successful, gives permission for the application to continue running. The DRM subprogram embedded in the application verifies the validity of the permission to continue working, and, if the verification has failed, terminates the running of the application otherwise, the application continues running.

When the application has finished working (for example, the user has terminated the application), the DRM subprogram informs the DRM server about the fact that the application is no longer running.

If the licensed object at issue is a document or file containing protected content, the actions performed when accessing that licensed object are generally similar to those when working with an application. The primary difference is that instead of a DRM subprogram embedded into the application, all operations regarding receiving permissions for opening the document or file and for continuing to work with the document or file, as well as relating to informing the DRM server about finishing the access to the document or file, are performed by a special module for viewing or working with the digital content.

If the licensed object at issue is a service, when the service is initially accessed, and when the use of the service is terminated, generally similar actions are performed, compared to working with the application. The primary differences are that when using a service as a licensed object, the end user sends a request to the server that provides the service and provides his identifier or the identifier of the license. The operations required to receive permission to provide this service and to continue providing this service, as well as informing the DRM server about the end of the use of the service, are performed by the server that provides the service, rather than by an application on the client side.

In all three cases (for applications, for digital content and for services) the logic of operations on the DRM server side, regarding the verification of the licenses is generally the same:

When a request for permission to use a licensed object is received by the DRM server, the DRM server checks, in its database, for a license for the identified licensed object for the user with the specified identifier. Then, the DRM server checks whether the licensed object can be used at the given moment and time. The DRM server also checks whether the number of permitted uses of the licensed object has not been exceeded, and that the time of use of the licensed object has not been exceeded. The DRM server can also check if the number of simultaneous uses of the licensed object has not been exceeded. If the verification is successful, the DRM server sends permission for use of the licensed object, increases the counters of the number of uses of a licensed object and the number of simultaneous uses of the licensed object.

When a request for permission to continue using a licensed object is received by the DRM server, the DRM server updates the counter of the time that the licensed object has been used, verifies whether the license can be used at the current moment in time, verifies whether the number of uses of the license has not be exceeded, verified whether the allowed time for use of the licensed object has not been exceeded, and in the event of successful verification, gives permission to continue using the licensed object.

Upon being informed that the use of the licensed object is over, or when a time out (from the last receipt of request for permission to use a licensed object or to continue using the licensed object) has been reached, the DRM server reduces the counter of simultaneous current uses of the licensed object.

In an alternative embodiment, periodic requests to the DRM server to continue using the licensed object are not necessary. In this case, the counter of simultaneous uses of the licensed object is reduced only upon time out from the moment when a permission to use the licensed object has been given, while a limitation on the time that the license can be used is not implemented.

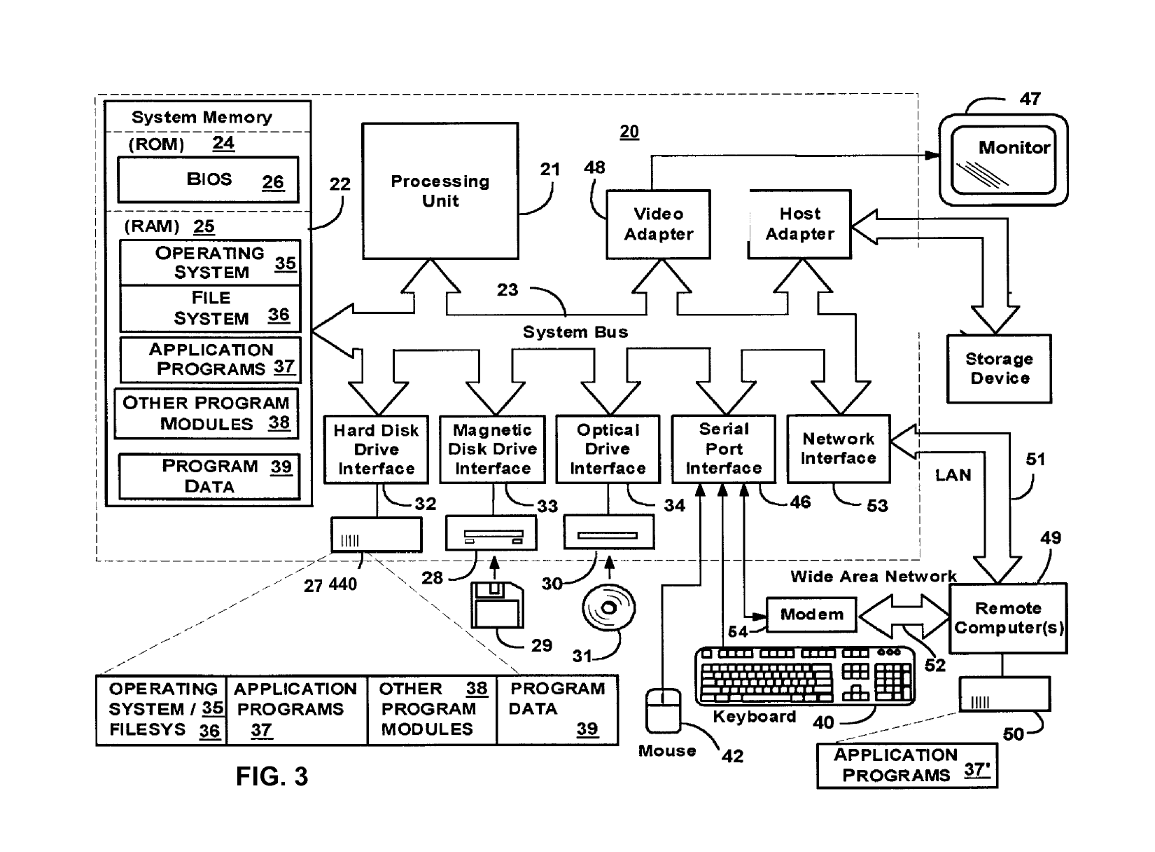

With reference to FIG. 3, an exemplary system for implementing the invention includes a general purpose computing device in the form of a personal computer (or a node) 104 or server or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25.

A basic input/output system 26 (BIOS), containing the basic routines that help to transfer information between elements within the computer 20, such as during start-up, is stored in ROM 24. The personal computer/node 20 may further include a hard disk drive for reading from and writing to a hard disk, not shown, a magnetic disk drive 28 for reading from or writing to a removable magnetic disk 29, and an optical disk drive 30 for reading from or writing to a removable optical disk 31 such as a CD-ROM, DVD-ROM or other optical media.

The hard disk drive, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer 20.

Although the exemplary environment described herein employs a hard disk, a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35 (such as WINDOWS™ or LINUX). The computer 20 includes a file system 36 associated with or included within the operating system 35, such as the WINDOWS NT™ File System (NTFS), one or more application programs 37, other program modules 38 and program data 39. A user may enter commands and information into the personal computer 20 through input devices such as a keyboard 40 and pointing device 42.

Other input devices (not shown) may include a microphone, joystick, game pad, satellite dish, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48.

In addition to the monitor 47, personal computers typically include other peripheral output devices (not shown), such as speakers and printers. A data storage device, such as a hard disk drive, a magnetic tape, or other type of storage device is also connected to the system bus 23 via an interface, such as a host adapter via a connection interface, such as Integrated Drive Electronics (IDE), Advanced Technology Attachment (ATA), Ultra ATA, Small Computer System Interface (SCSI), SATA, Serial SCSI and the like.

The computer 20 may operate in a networked environment using logical connections to one or more remote computers 49. The remote computer (or computers) 49 may be another personal computer, a server, a router, a network PC, a peer device or other common network node, and typically includes many or all of the elements described above relative to the computer 20.

The computer 20 may further include a memory storage device 50. The logical connections include a local area network (LAN) 51 and a wide area network (WAN) 52. Such networking environments are commonplace in offices, enterprise-wide computer networks, Intranets and the Internet. When used in a LAN networking environment, the personal computer 20 is connected to the local area network 51 through a network interface or adapter 53.

When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

Those skilled in the art will appreciate that proposed method allows for effective end user license management. Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A computer-implemented method for end user license management, the method comprising:
maintaining a server-side database of information about licensed objects, the licensed objects including application software, digital content and services;
at the server, verifying validity of a license upon a request from an end user to utilize the licensed object;
providing, to the end user, permission to use the licensed object when the verification is successful;
rejecting the request to use the licensed object when the verification is not successful;
periodically receiving requests to continue utilize the licensed object, and verifying continued validity of a license held by the end user;
providing, to the end user, continued permission to use the licensed object when the verification is successful; and
rejecting the request to continue using the licensed object when the verification is not successful.

2. The method of claim 1, wherein the licenses for the application software, the digital content and the services utilize a uniform representation model that includes fields for:
licensed object identifier;
end user identifier;
unique license identifier;
time of start of use of the licensed object;
maximum permitted time of use of the licensed object;
maximum number of times the licensed object can be used;
maximum number of simultaneous uses of the licensed object;
current counter of time of use of the licensed object;
current counter of number of uses of the licensed object;
counter of number of current simultaneous uses of the licensed object.

3. The method of claim 1, wherein the verification is performed at each attempt to utilize the licensed object.

4. A system for end user license management comprising:
a processor;
a memory coupled to the processor;
a computer program logic stored in the memory and executed on the processor, the computer program logic for executing the steps of claim 1.

5. A non-transitory computer-useable storage medium comprising code for performing the steps of claim 1.
